(19) United States
(12) Patent Application Publication
(10) Pub. No.: US 2003/0233619 A1
(43) Pub. Date: Dec. 18, 2003

(54) Process for locating data fields on electronic images of complex-structured forms or documents

(76) Inventor: Bruce Brian Fast, Whitehorse (CA)

Correspondence Address: Bruce Brian Fast, Suite 12, 4078 4th Ave., Whitehorse, YT, Y1A 4K8, CA

(21) Appl. No.: 10/384,040

(22) Filed: Mar. 10, 2003

Related U.S. Application Data
(60) Provisional application No. 60/383,930, filed on May 30, 2002.

(51) Int. Cl. G06F 15/00

(52) U.S. Cl. 715/517

(57) ABSTRACT

A process for locating data fields on electronic images of complex-structured forms or documents. with the steps of: locating the approximate location of one field of data, of establishing the precise location of data based upon the approximate location, of establishing the approximate locations of a plurality of fields of data based upon the precisely located data, and of establishing the precise location of data for a plurality of the fields based upon the approximate locations.

### CROSS REFERENCE TO RELATED APPLICATIONS

This application is based on provisional application serial No. 60-383930, filed on May 30, 2002.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of document imaging and more specifically to a process for locating data fields on electronic images of complex-structured forms or documents.

Forms have been used by companies for many years to either give or recieve communications. Such forms are commonly used as invoices, statements, and a miriad of other communications. Forms are traditionally designed with specific boxes, lines, combs (fields) or columns, where the data that is imprinted in any particular field or column always has a consistant contextual meaning. For instance, a ‘name’ field will have a name in it. This common feature of forms allowed some to develop techonologies to locate the data on forms so that the data could be reliably converted from paper to database form. The dominant technologies today rely on the expectation that data in a particular field or column will have this consistant contextual meaning.

Two types of documents have refused to fit into this pattern, however. In some cases forms are not filled out the way that the form designer intended. For instance, it is common for columns that are supposed to contain part numbers, descriptions and quantities to carry extended descriptions, modification notices, or other messages. Such information, presented on a form, but not strictly adhering to the simple rule that fields and columns will always have consistant contextual meaning has proved impossible to be automated by traditional means.

A second type of document that has some form-like characteristics, but does not maintain the above described discipline is the structured printed report. Structured printed reports are primarily used to output a large quantity of data records. Because they are often extensive, taking up multiple pages, they frequently pay little attention to page boundaries. Frequently these reports have multiple different structured lines. It is common for them to present multiple records, each record having a header section of a plurality of lines, followed by a number of sub-record lines. These are often interspersed with exception lines. The complexity of these documents has all but illuded the automation process.

Note that a third challenge exists in forms processing, the challenge of receiving forms from a multitude of sources, each one being slightly different, but all containing similar types of information, such as invoices received by a variety of companies. This particular forms processing challenge is not the primary focus of this invention. The processing of simple forms has been dominated by a technique called ‘templates’. In general, this technique involves having a map of the fields for a given form, each field knowing the type of data to expect in it. The map is overlayed on the form's image, and micro-positioned based upon constants found on the form. For many forms processing situations, especially where the form is clear and un-cluttered, this approach has worked well. However, when the rules of simple forms are broken, this technology falls apart. Further, the technology tends not to work well if the form has a lot of information on it, or if the form has issues of distortion such as magnification (especially a different amount of horizontal or vertical maginfication) or skew.

A second technique has been developed expressly for dealing with the challenge of dealing with differing forms from multiple sources. This technique involves finding key features and reading key-words, then based upon the tradition of the class of document, guessing which image data represents which type of data. For instance, if this technology finds the word “Name” on an image, it would guess that the data to the right of this word is likely to be the name of an individual or company. While this technology does address the challenge of dealing with differing forms from multiple sources, it also is not proficient at dealing with forms whose data do not hold to the rules. It does not begin to address the structured printed report problem. It is more robust than the template method with reguard to issues of distortion, however, it is generally significantly less accurate than the template method when dealing with clean, known forms, simply because it is ‘guessing.’

Two prior technologies have proven capable of dealing with the challenges of structured printed reports, at least one is capable also of processing complex-structured forms.

The first is a product called FormMapper(tm), originally from TeraForm, Inc., now owned by DocuStream Inc., (California companies.) This technology, believed to be in the public domain, uses a technique called navigation. It finds data fields one at a time, based upon a custom program that is written for each document class. This technique is explained further in the Detailed Description of the Preferred Embodiment of this document. While this technology is capable of finding data on complex-structure forms and on structured documents, the fact that complex rules must be developed for each field of found data results in a prohibitive time-cost in configuring the system to process a new document type. The real world difference between the two technologies from a configuration standpoint is that a document structure that requires 2 months configuration effort with this navigation technology is configured in 4 hours with the technology herein disclosed.

The second is a product called EOBAgent(tm), marketed by CereSoft, Inc. (a Maryland Company.) The exact techniques used in this technology are not made public. A patent search has not produced a patent for this technology. However, the company does have a reputation for requiring extensive configuration times for their technology, therefore it is believed that this technology is more like TeraForm's FormMapper technology than it is like the invention described herein.

To the best of my knowledge this is the current state of the art.

It is therefore believed that the invention described herein offers an ability to process complex-structured documents and structured printed reports that template technology and keyword finding technology are simply incapable of processing. Further it is believed that the invention described herein offers a significant advantage over technologies such as FormMapper(tm) and EOBAgent(tm) in that these technologies have a prohibitive configuration issue.

### BRIEF SUMMARY OF THE INVENTION

The primary object of the invention is to locate data in images of forms or documents whose structure is more complex than other systems can process.

Another object of the invention is to permit easy configuration of a system that can locate data in image of forms or documents with a complex structure.

Another object of the invention is to find data on forms and documents even when significant distortion such as skew, magnification and noise, is encountered.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for locating data fields on electronic images of complex-structured forms or documents. comprising the steps of: a step for locating the approximate location of one field of data, a step for establishing the precise location of data based upon said approximate location, a step for establishing the approximate locations of a plurality of fields of data based upon said precisely located data, and a step for establishing the precise location of data for a plurality of said fields based upon said approximate locations.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the operations that comprise the configuration of a formlet.

FIG. 2 is a flow chart of the operations that comprise the application of a formlet.

FIG. 3 is a diagram of a formlet definition overlaid on an image of a document.

FIG. 4 is a flow chart of the operations that comprise the finding of specific data based upon an approximate location.

FIG. 5 is a diagram illustrating the method of locating data using the ‘fully contained’ method.

FIG. 6 is a diagram illustrating the method of locating data using the ‘touching’ method.

FIG. 7 is a diagram illustrating the method of locating data using the ‘grow until’ method.

FIG. 8 is a diagram illustrating the prior art method of navigating to find a specific image location.

FIG. 9 is a diagram illustrating the finding of correlated point in a left justified field.

FIG. 10 is a diagram illustrating the finding of correlated points in a left justified baseline field.

FIG. 11 is a diagram illustrating the finding of correlated points in a right justified field.

FIG. 12 is a diagram illustrating the finding of correlated points in a right justified mulit-line field.

FIG. 13 is a diagram illustrating a formlet application overlaid on an image.

FIG. 14a is a diagram illustrating a first stage of applying a formlet.

FIG. 14b is a diagram illustrating a second stage of applying a formlet.

FIG. 14c is a diagram illustrating a third stage of applying a formlet.

FIG. 14d is a diagram illustrating a fourth stage of applying a formlet—linking a subsequent formlet application.

FIG. 15a is a diagram illustrating a first stage of applying a formlet by the dynamic application method.

FIG. 15b is a diagram illustrating a second stage of applying a formlet by the dynamic application method.

FIG. 15c is a diagram illustrating a third stage of applying a formlet by the dynamic application method.

FIG. 16a is a diagram illustrating the application of a ‘line-item’ formlet to a “CLAIM TOTALS” line.

FIG. 16b is a diagram illustrating the application of a ‘line-item’ formlet to a “REM:” line.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The technology described herein is capable of locating data fields on electronic images of documents, where such images are held in computer memory as is commonly done in the field of image processing.

This technology requires a searchable map of image features. What is required is a series of one or more lists of image features. The simples image feature is commonly referred to as an ‘image object’. An image object is any pixel of a given color, and all pixels that touch it. More complex features include: letters, where letters made up of multiple objects such as an (i) are seen as a single feature; words, which are groups of letters, often including the natural baseline, where letters with descenders extend below said baseline; lines of text, groups of words that have the same baseline; and undefined features, image objects which are not identified as letters, punctuation, words etc. Other image features can include horizontal and vertical lines, and similar features as commonly located by image enhancement technologies.

Said searchable map of image features technology is commercially available from at least three sources. TMSSequoia, Inc. (Oklahoma) sells a product, FormFix™ which provides a searchable list of all black and all white image objects. TMSSequoia's ScanFix™ outputs other maps of image features such as the location of horizontal and vertical lines. Expervision Inc. (California) has an OCR technology that is capable of outputting the bounding boxes of the letters and words on a document. GenieTek Innovations, Inc. (YT, Canada) has marketed a “decomposition engine” product which is capable of generating said maps of image features where features can be defined as: ‘image objects’, letters, punctuation, words, lines of text, undefined features and others. I choose a combination of the latter technology with any one of the image enhancement tools to report the location of horizontal or vertical lines.

A searchable map of image features will be referred to in this document as features.

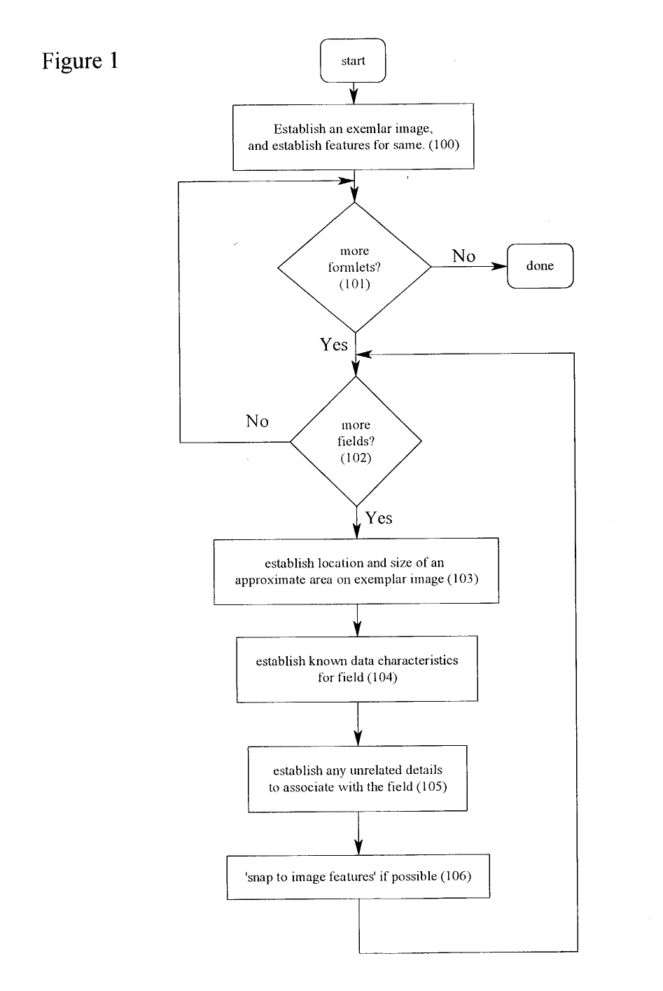

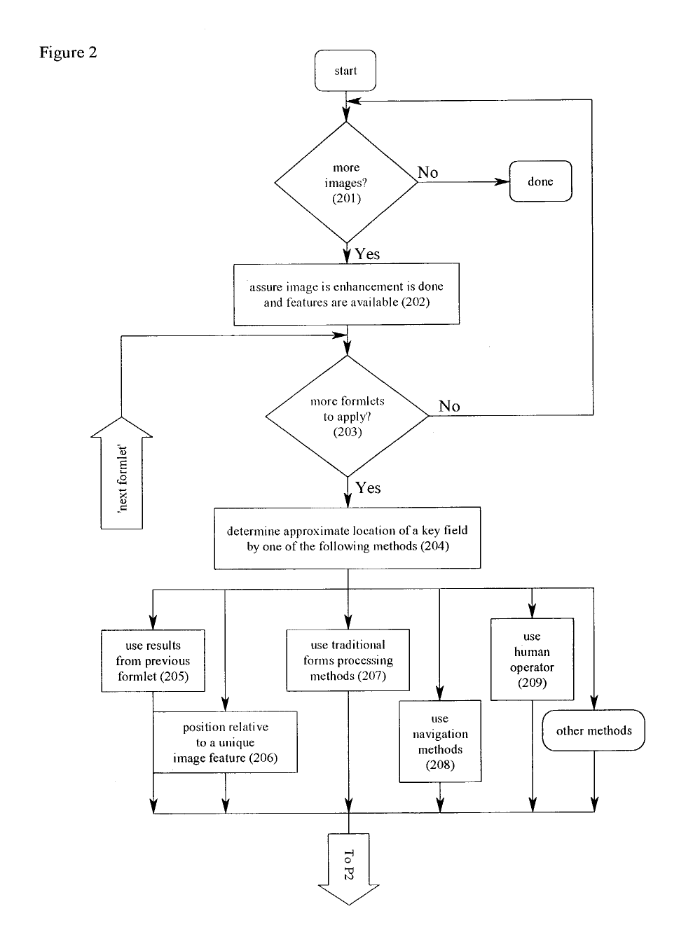

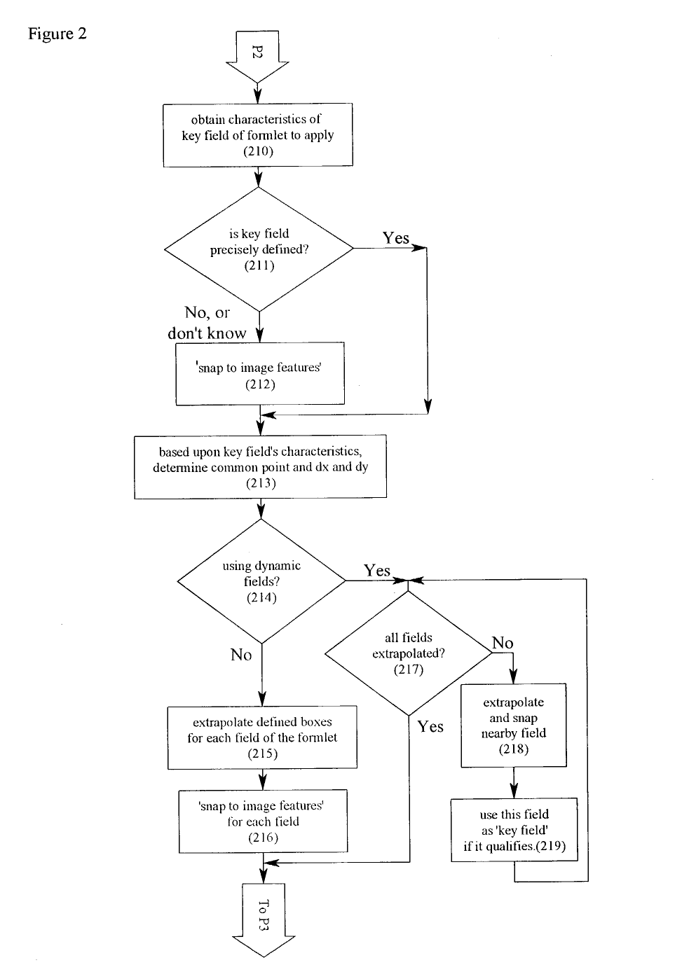

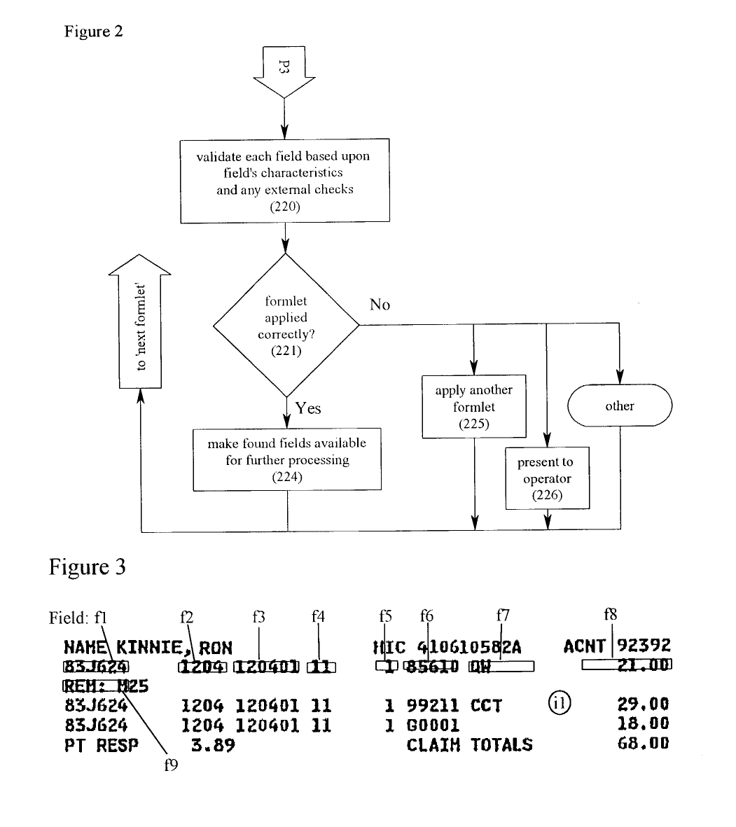

Please consider the two flow charts, FIG. 1 and FIG. 2.

FIG. 1 clarifies the process of providing one or more maps of approximate locations of a pattern of fields.

I will heretofore use the term formlet to mean, “a map of approximate locations of a pattern of fields.”

To prepare to provide said formlet, an exemplar image, usually an image containing a complete example of the segment of data being mapped, must be established, and features for said exemplar image must be established (100). The features for said image must be available.

A formlet consists of a plurality of fields (101, 102). I define the following details for each field of a formlet:

The location and size of a bounding box of an approximate area in the exemplar where image feature analysis will take place in the forthcoming images to be processed (103).

The known data characteristics of the data expected in the field (104).

Other characteristics may be defined such as OCR parameters, and where the data is to go in the database (105).

The actual location and size of and area containing features within said searchable mapping of features in said exemplar image (106) which correlate to the approximate area associated with said field. This may be referred to as exemplar data. The process of establishing the location and size of said area containing features which correlate to an approximate area will heretofore be referred to as ‘snapping to image features’, or ‘snapping’. This process of snapping will be explained detail.

As an example of the above process, consider FIG. 3 which defines a ‘line item’ formlet. As per step (103), I begin with an exemplar image (i1) for which features have been established. Using said image, I establish the bounding boxes of an approximate area for each field (f1-f9). Normally this is done by having a human operator ‘drag’ boxes on an electronic representation of the image.

Alternatively, methods such as navigation (prior art, detailed description to follow) can be used to locate the approximate locations of fields. Consider, for instance the following real-world example. I was given a variety of documents that were known to each have five columns of data. However, the width of each column, and the line spacing, though consistent per image, were not in any way consistent image-to-image. Using navigation, I was able to locate an exemplar line of data, and create a formlet definition based upon that. The process of marrying navigation technology with the formlet technology defined here, resulted in significant configuration time savings, as well as significantly improved output data quality.

As per step (104), for each field (f1 through f9) I define some information. In this case, for fields f1 through f8, I define to ‘snap to image features’ where I define to use ‘word’ type features. I also define, for said fields that snapping will be done using the ‘touching’ method, (as will be explained.) I define fields f1 through f7 as left justified fields, I define field f8 as a right justified field. (Details about the connotations of left and right justified fields to follow.) I do not define ‘snap to image features’ for f9 in this case because field f9 is used only to start the next formlet. Leaving it unsnapped allows it to be useful for a variety of formlet types that may follow the application of said exemplar formlet in any future contexts.

As per step (105), for each field (f1 through f9) I may associate other details. For instance, I may declare that field f9 is not used for OCR processing, and that f8 is going to contain a dollar amount.

As per step (106), now that fields f1 through f9, and the characteristics of said fields are defined, the bounding box that contains the exact location of data in said exemplar image can be established.

I perform the process of ‘snapping to image features’ as follows:

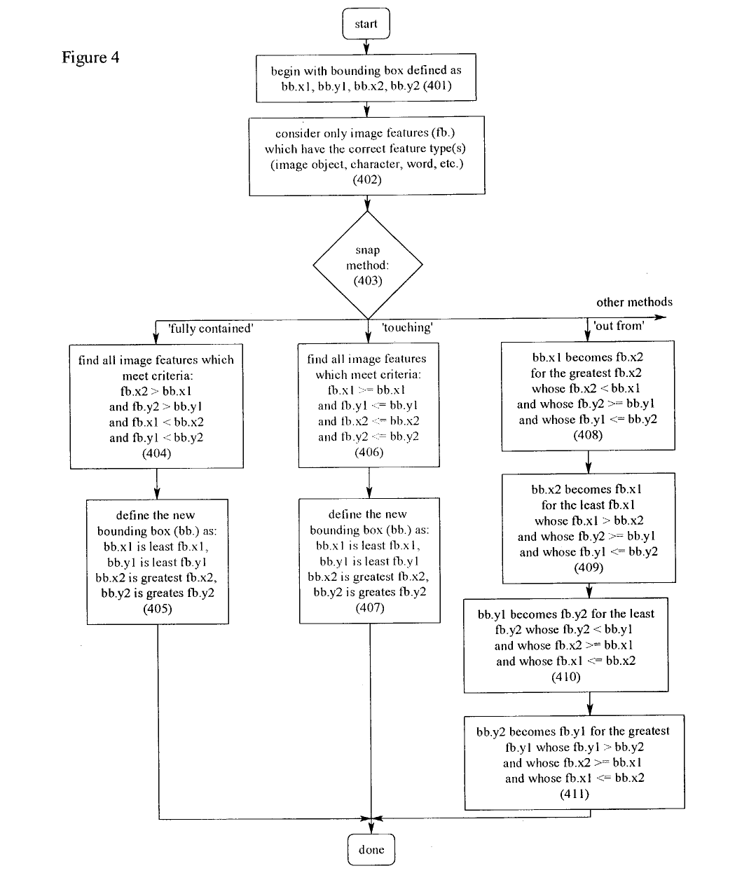

Please consider flowchart FIG. 4.

We will observe how the exact location of the exemplar data for said field f1 is established. We begin with bounding box bb.x1, bb.y1, bb.x2 and bb.y2 in step (401). This is the currently defined approximate area of said field f1.

Step (402) requires considering only the features of the ‘correct feature type(s)’. This was established in said field f1, during said step (104) as ‘words’. Therefore only word-scope features will be considered for this analysis.

In decision (403) we need to know the snapping method. In said step (104) this has been established for said field f1 as ‘touching’.

When we apply the formula defined in steps (406) and (407) we get the results similar to those viewed in FIG. 6. In other words, to snap ‘touching’, we locate all features (of our select feature type) which at least partly overlap the approximate area under consideration. We report the area of the found data to be the smallest bounding box that fully contains said located features.

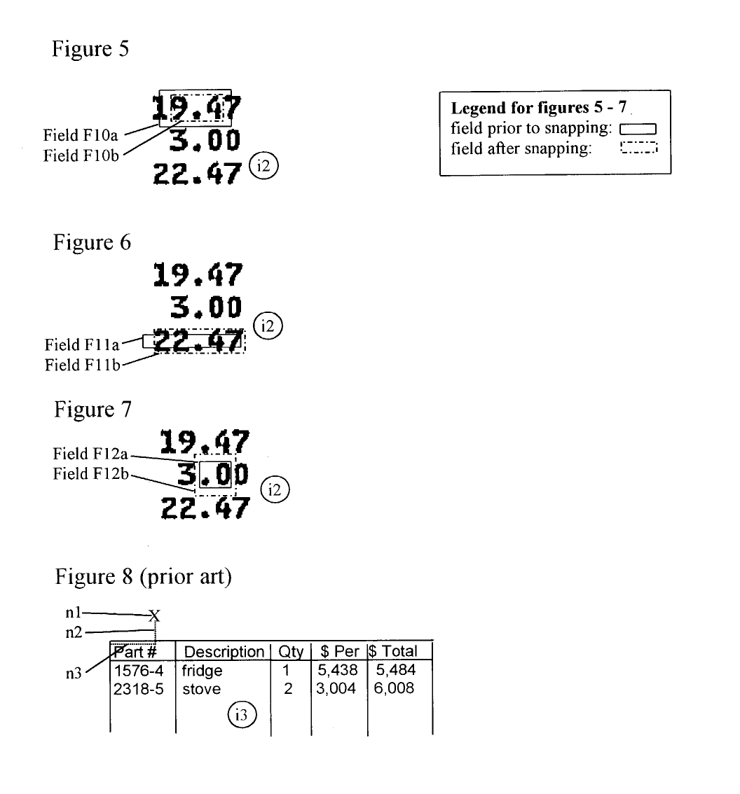

FIG. 5 illustrates the effect of applying snapping method ‘fully contained’ (steps (404) and (405)) to an approximately defined field (f10a) producing exact field (f10b). (Note that said FIG. 5 shows snapping to ‘simple objects’ or ‘letters’). In this case, we locate all features (of the select feature type) whose area is fully within the approximate area under consideration. We report the area of the found data to be the smallest bounding box that fully contains said located features.

Likewise FIG. 7 illustrates the effect of applying snapping method ‘grow until’ to a field. In this case approximate field f12a produces exact field f12b. (Note that said FIG. 7 shows snapping to ‘simple objects’ or ‘letters’). In this case, we locate the first feature (of the select feature type) above, below to the left and to the right of the approximate area under consideration. We report the area of the found data to be the largest bounding box that is just to the right of said feature found to the left, just below said feature found above, just to the left of said feature found to the right, and just above said feature found below.

Note that other ‘snapping methods’ may be defined.

Note that for any given field, I may either declare that snapping is not to be done, or the exemplar image may have no data for a field even though I declared said field. In these cases there is no valid exemplar data associated with said defined field. (Field f9 illustrates an example where no snapping has been defined.) When there is no exemplar data associated with a field's definition, this field cannot be used later as the ‘key field’ for formlet application. For functional formlet to be defined, at least one field must have valid exemplar data.

As per (101) of FIG. 1, the above process is repeated for each of the various formlets that make up the variety that is to be expected from a given document. In said example image (i1) we can see that formlets will be necessary at least for:

The ‘line item’ lines, as said description illustrates

The line containing words: “NAME”, “HIC” and “ACNT”

The line containing the word: “REM:”

The line containing the words: “CLAIM TOTALS”

Note that although these examples only show formlets that are one line deep, this is not the exclusive case, a formlet can be of any dimension from 2 fields, to the entire image.

FIG. 2 summarizes the use of formlets for finding data in documents as follows:

As per step (202), for each image to be processed, the image features must be available. It is normal also to enhance the image to remove undesirable characteristics such as skew, noise, lines etc. Enhancement technologies usually communicate the location of removed lines etc, which I have made available to this formlet technology as more types of features.

To apply a formlet, the approximate location of a ‘key field’ must be established (step 204). Any field in the formlet definition to be applied which has associated exemplar data may be used as a key field.

I have used each of the following methods of locating the approximate location of an initial formlet field or ‘key field’:

Step (205), once a formlet is applied, it often supplies the information necessary for finding the key field in the next formlet. Said field f9 will be used in future examples to demonstrate this.

Step (206), I have successfully looked for a unique image feature, and taken a position relative to that unique image feature as a ‘key field’ position. For instance, if an image contains an anchor point or distinctive logo, prior art methods can easily locate it. Such, in fact, usually show up as ‘undefined features’ by feature analysis technology.

Step (207), as documents frequently have a very form-like header, any of the available prior art template forms processing techniques can be used to do forms id on the header of the page, and once they have located the consistent header, one of the data elements of said header can be used as a ‘key field’ for this processing. (In fact it is reasonable with many forms that have a consistent header, but complex structure in a table section to use prior art forms processing techniques, then use the technology defined here to parse said table section.)

Step (208), one can navigate around the document looking for a familiar pattern of image features which can be used to locate a ‘key field’. For instance, one can seek the horizontal line down from a given point, then seek the leftmost vertical line in the document which is just below the found horizontal line. At that time a point on the document is determined. One can then use that point to extrapolate the approximate location of a ‘key field’ See FIG. 8. (This prior art technology is available in a product called FormMapper from DocuStream Inc., initially developed by TeraForm Inc., and is believed to be in the public domain.)

Let us quickly consider FIG. 8. An initial location n1 is a starting point selected to be ‘close enough’. The focus of navigation is moved along path n2 until the first line is encountered. Then focus is moved along path n3 just below the line found until the first vertical line is found. In this case the upper-left corner of a table seen in image i3 is precisely located. From that point it is easy to extrapolate an ‘approximate location’ of the nearby fields.

Step (209), one can have a human operator select an area on an image, and inform the program that this area is the approximate location of data for a particular formlet and a particular ‘key field’ within said formlet.

Other techniques for locating a ‘key field’ could be used without diminishing the value of this technology.

Note that the above may be known to locate the precise area of the features in the ‘key field’. In this case, the step of moving from approximate to precise area discussed below may be skipped, as per decision (211).

Once the approximate area of a ‘key field’ is determined, and it is determined which formlet one wishes to apply at that field and which field within the formlet is to match the approximate location of said ‘key field’, then, based upon the known characteristics of said field, we will ‘snap to the image features’ (as described above), locating the precise area of the found data to associate with said key field.

Once we know where said found data for said key field is, we use the known characteristics of said field to determine a point that correlates said found data with the exemplar data associated with the definition of said key field. Consider how this is done with four examples:

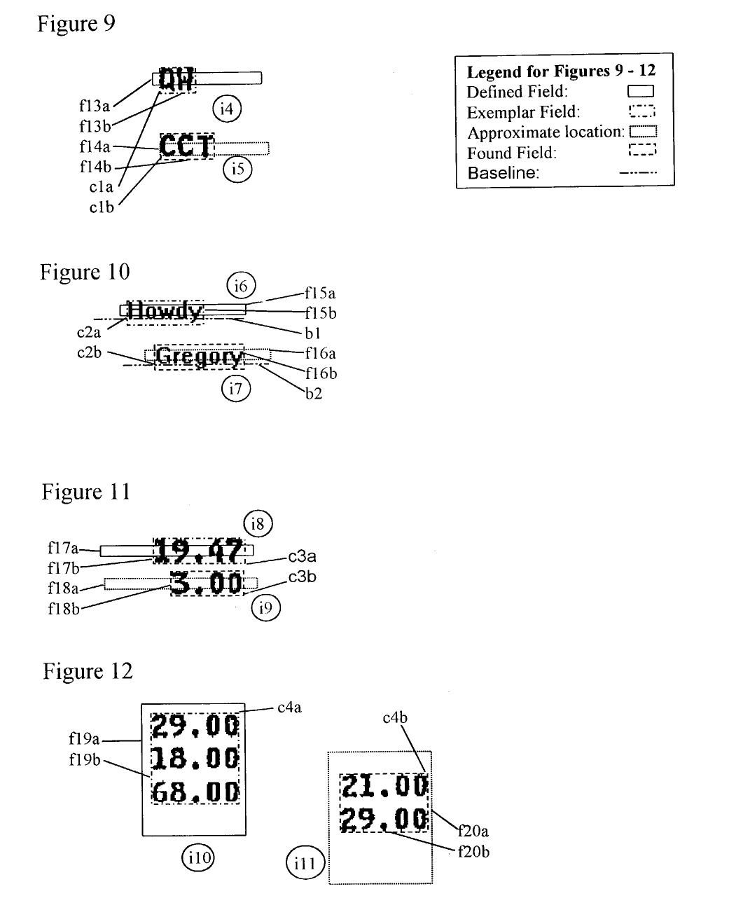

Example 1, See FIG. 9. This is an example of a left justified field. In this case I choose to correlate the lower left corner of the bounding box of said found data (f14b) with the lower left corner of said exemplar data (f13b) associated with said key field's definition, represented by c1b and c1a respectively.

Example 2, See FIG. 10. In this case, the feature analysis technology presents the baseline of text. (Working off the baseline, rather than the bottom of the box eliminate any error due to descenders.) The x axis of correlated points c2a and c2b is determined based upon the left edge of the bounding boxes f15b and f16b. The y axis of said correlated points c2a and c2b are calculated from baselines b1 and b2 respectively. (Note that baseline information c2a would have had to have been recorded in association with the formlet's definition when the exemplar data was determined for that definition.)

Other information returned by analysis technology could reasonably be integrated without diminishing from the value of this work.

Example 2, See FIG. 11. This is an example of a right justified field. In this case I choose to correlate the lower right corner of the found data (c3b) with the lower right corner of the associated exemplar data (c3a).

Example 3, See FIG. 12. This is an example of a right justified, multi-line field. In this case I would choose the top right of both the relevant found data and the relevant exemplar data, c4b and c4a respectively as my correlated points.

Other sets of known characteristics are possible, each of which may have a plurality of methods whereby a correlated point may be determined.

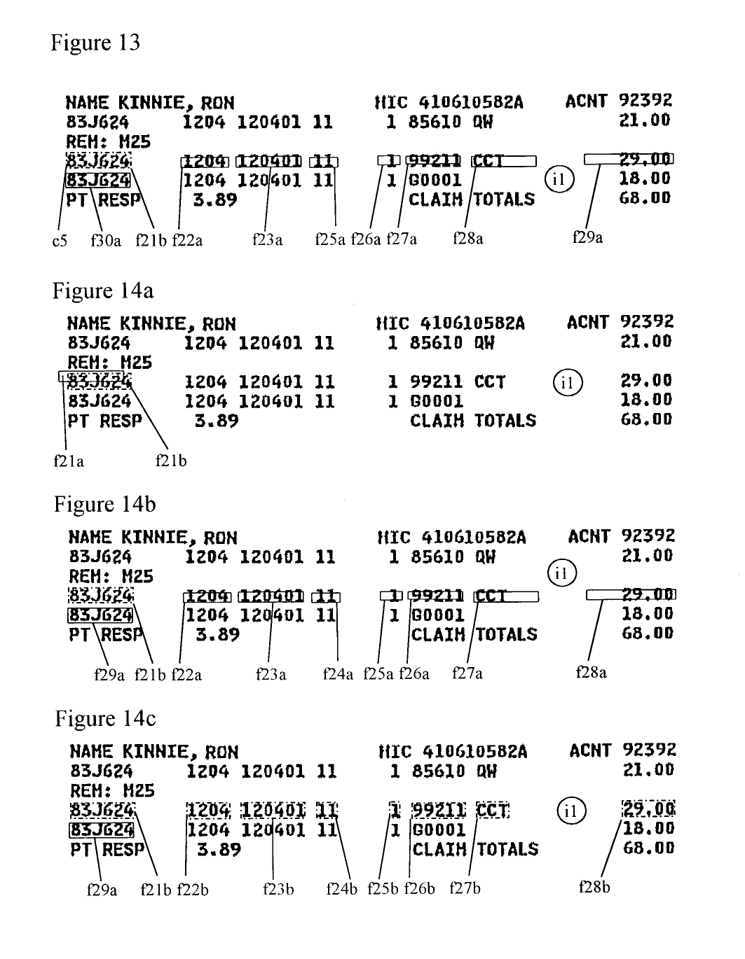

Once the correlated point is determined, I calculate a dx and a dy, the amount of horizontal and vertical shift necessary to shift from the relevant exemplar data's correlated point to the relevant found data's correlated point. I then create bounding boxes for each field of my applied formlet by extrapolating from my formlet definition (with the exception of the key field). This is simply done by adding dx to the x coordinates of the bound box of each field's approximate location, and adding dy to the y coordinates of the bounding box of each field's approximate location. The results of this extrapolation, using said formlet definition established above can be clearly seen in FIG. 13. In this case, field f21b is our ‘key field’ data precisely located. The other fields have been extrapolated from said formlet definition according to the above formula. Point c5 correlates to the lower left corner of the exemplar data associated with field f1 in FIG. 3.

For each field of the formlet, I then ‘snap to the image features’ via the method established for each field of the relevant formlet's definition. Once this is done, all of the data related to this formlet has been located.

We can then confirm, either based upon characteristics defined with the field, such as ‘data must not be found here’ or ‘the data must be about the same size as the exemplar’ or by external means (For instance, we could OCR a field at this point to see if it contains a particular word.), whether the data found in all of the fields is within the expectations for said fields. This is what I refer to as ‘formlet id’. If the data is not with said expectations, we could apply a variety of methods of responding such as applying a different formlet using the same initial approximate field location, or presenting the image to a human operator for intervention.

If the formlet meets the above expectations, the found fields can be used for further processing such as saving in a database, passing to an OCR or presenting to a human operator to ‘key from image’.

Further, a field from this formlet application can be used as a ‘key field’ for the next formlet application, or can be used as a starting point for analysis (such as searching for an image feature with a certain characteristic) that will be used for the application of the next formlet.

It is normal to save the data found in each application of the formlet into a database in the same order in each case, or by other means maintain the order that data is found. The resulting order is useful information for future data processing.

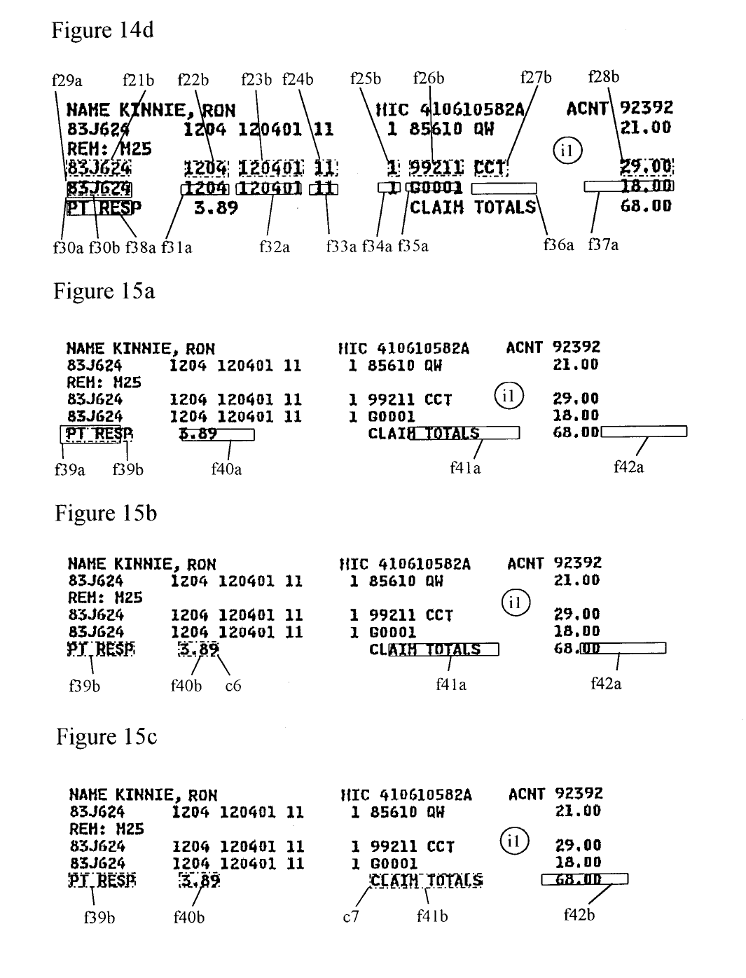

Let me now present FIGS. 14a-14d to illustrate the process of applying a formlet, step by step.

In FIG. 14a, we again examine image i1. In this case we have established an approximate location for key field f1 in said formlet definition, as f21a. (We have done a particularly poor job of establishing this approximate location to illustrate the robustness of this technique.) We have ‘snapped’ to the data. (Remember that said field f1 is defined to snap to ‘words’.) F21b is the result of snapping, the found data.

When we extrapolate each field of said formlet definition based upon the relationship between said found data and said exemplar data for said field definition f1, we see the results in FIG. 14b, fields: f22a through f29a.

FIG. 14c illustrates the results we get when we snap each of these fields according to the method provided by their respective formlet definitions. The results are seen in f22b through f28b. Note that for field definition f9, the definition associated with field f29a, we defined ‘no snap’, therefore we do not create an f29b.

In FIG. 14d, we use the position of f29a as an approximate key field for our next formlet application. We will again apply said formlet definition, f29a becomes approximate key field f30a for the next application of said formlet definition which we see just prior to snapping fields f31a through f37a.

Though the above method is what I currently use, because it is straightforward and sufficiently robust for most real-world conditions. I have considered a more complex approach to formlet application, an approach that would be more forgiving of image issues such as unexpected image magnification, and of image skew than the above is. In this approach, as we extrapolate formlet fields, we will use the most nearby found field as our ‘key field’ rather than just the key field first established. (Of course, if the nearby field does not qualify as a key field because either it does not have exemplar data associated with it, or no found data was located, then the most nearby field that does qualify will be used.)

FIGS. 15a through 15c illustrate the method and effects of using the alternative ‘dynamic fields’ processing technique considered in FIG. 2 (214).

First, let's look at FIG. 15a. We are applying a formlet definition which would fit better on a more magnified image. We have located data f39b, as the precise found data for field f39. Based on said formlet definition, we have extrapolated fields f40a through f42a. We note that field f42a is significantly misaligned.

In FIG. 15b, we snap to field f40a to produce precise found data f40b. As f40b can be used as a key field (it has found data, and the associated field in said formlet definition has exemplar data), we use f40b to extrapolate new positions for fields f41a and f42a. (After all f40b is closer to f41a and f42a than f39b is.) When we do so, we see that field f41a and f42a are at least a closer fit to the data.

In FIG. 15c, we snap to field f41a. (Note that this would require ‘word’ scope snapping.) Our precise found data is f41b. We now said f41b to reposition f42a. Now f42a is close enough to it's intended data that we will successfully get results. Other significant notes: Because formlets are applied exclusively on image features, rather than on pixels (though pixels could be used as image features) it becomes extremely easy to extrapolate bounding boxes of the image features (my choice in approach, alternatively the formlet's definition could be extrapolated) based upon the recorded or measured resolution of the image.

I, for instance, extrapolate all image features to what they would be in a 300 dpi image. So if I receive a low resolution fax (approximately 100 dpi * 200 dpi) all vertical measurements are multiplied by 3 and all horizontal measurements are multiplied by 3/2. This is extrapolation based upon the recorded image.

Alternatively, one could locate known artifacts in an image, and extrapolate based upon the measured distances compared to the expected distances.

It also seems possible to extrapolate for skew, though my current implementation counts on image enhancement technology to remove skew.

Note, however, that the approach of using course features such as words, using relatively small ‘formlets’ and using ‘snap to the image features’ technology produces the effect of a template system that is much less sensitive to distortions caused by small resolution changes and skew than more simplistic template technologies are.

Finally, let us closely examine the effects of applying a formlet definition on data that does not meet the formlet definition's criteria, flowchart FIG. 2 (220). We see how this approach is useful in doing on the fly formlet id.

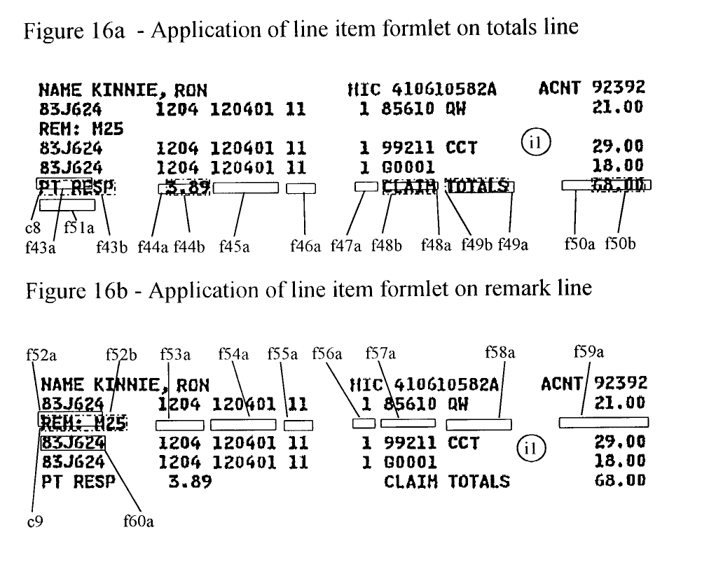

Please consider FIGS. 16a and 16b.

In FIG. 16a we illustrate applying our original formlet definition (FIG. 3) on a line containing the word “CLAIM TOTALS”. When this application is made, many of the fields (f43a, f44a, f48a, f49a, and f50a) land over valid data. In fact, if we consider field f50, we see that it would be very hard to determine from the exact found data of said field that this field was not appropriate as an application of said ‘line item’ formlet definition. However, the fact that f45a, f46a and f47a always have data in a valid application of said ‘line item’ formlet definition, and that all three of these do not have such in this application, we can conclude that the application of said formlet definition is invalid.

In FIG. 16b, we illustrate similar, applying said formlet definition to a line containing the word “REM:”. Again, when we discover that no exact found data is located for fields where any valid application of said formlet definition would find data, we conclude that the application of said formlet definition is invalid.

When the discovery is made that a formlet definition does not correctly apply, we must respond appropriately. A few options are presented in flowchart FIG. 2. In option (225) we would use the same approximate location of a key field as the key data for a different formlet definition, or as a different field within this formlet definition. In the above two examples (FIGS. 16a and 16b) we would apply different formlet definitions. For the situation in FIG. 16a, we would apply a formlet definition suited for processing ‘claim totals’ lines, and for FIG. 16b we would apply a formlet for ‘rem:’ type lines. In either case, we may try a plurality of incorrect applications, until we discover a formlet definition that correctly applies. We would likely do this programmatically by associating a list of formlet/key-field pairs that would be expected in a given context. For instance, for said field definition f9, we would first consider to apply said ‘line-item’ formlet definition, then would consider to apply a ‘claim totals’ formlet definition, then consider to apply a ‘rem:’ formlet definition. If all of this produces no results, we may have to consider other alternatives.

I have applied a variety of other alternatives, such as examining whether the formlet

What is claimed is:

1. A process for locating data fields on electronic images of documents wherein:
A. providing a searchable mapping of the features of an image of a document wherein each mapping contains at least the location and size of each of said features,
B. providing one or more maps of approximate locations of a pattern of data fields, where:
(a) each of said fields in each of said maps contains at least location and size of an approximate area,
(b) each of said fields in each of said maps contains any known data characteristics such as an expectation that data will be left or right justified,
(c) at least one of said fields in each of said maps contains a mapping of the actual location of features within a searchable mapping of features in an exemplar image, herein referred to as exemplar data,
C. providing an approximate location within said searchable mapping of features, where one of said fields, herein referred to as a primary field, in one of said maps, herein referred to as a primary map, is expected to find data wherein said data field has an associated exemplar data,
D. a step for establishing a mapping of a selection of said features within said searchable mapping of features which correlate to said approximate location,
E. a step for extrapolating approximate locations for each of said fields except said primary field, within said primary map by shifting each of said approximate locations by the amount of shifting between a correlated point between said found data and said exemplar data associated with said primary field.
F. step for establishing a mapping of a selection of said features within said searchable mapping of features which correlate to said approximate locations for each of said fields used in step E wherein such a mapping is requested for said field,
whereby a pattern of fields is precisely located on images of documents, the results being suitable for data processing including OCR processing.

2. The process for locating data fields of claim 1 wherein said features are selected from the group consisting of: contiguous pixels of a given color, letters, words, horizontal lines, vertical lines, and unidentified image artifacts.

3. The process for locating data fields of claim 1 wherein there is an additional step for confirming that said selection of features established for each of said fields within said primary map is within the expectations for said field, and a method for responding when such requirements are not met, whereby the validity of the application of a particular map on an image at a particular location can be determined, permitting the application of an exception management approach such as applying an alternative mapping, reusing said found data.

4. The process for locating data fields of claim 1 wherein there is an additional step for using one of said mappings associated with one of said fields within said primary map as said approximate location of said step C for re-applying the procedure, associating said approximate location with one of said mappings, and using one of said fields within said mapping,
whereby multiple mappings can be assembled together to form a large, dynamically positioned meta-map of an image's fields.

5. The process for locating data fields of claim 1 wherein there is an additional step for using one of said mappings associated with one of said fields within said primary map as said approximate location of said step C for re-applying the procedure, associating said approximate location with one of said mappings, and using one of said fields within said mapping,
whereby a complex repetition of the application of multiple mapping types can be consecutively applied to images, establishing the locations, types, and order of a multitude of fields on complex structured documents.

6. A process for locating data fields on electronic images of documents wherein:
A. providing a searchable mapping of the features of an image of a document wherein each mapping contains at least the location and size of each of said features,
B. providing one or more maps of approximate locations of a pattern of data fields, where:
(a) each of said fields in each of said maps contains at least location and size of an approximate area,
(b) each of said fields in each of said maps contains any known data characteristics such as an expectation that data will be left or right justified,
(c) at least one of said fields in each of said maps contains a mapping of the actual location of features within a searchable mapping of features in an exemplar image, herein referred to as exemplar data,
C. providing an approximate location within said searchable mapping of features, where one of said fields, herein referred to as a primary field, in one of said maps, herein referred to as a primary map, is expected to find data wherein said data field has an associated exemplar data,
D. a step for establishing a mapping of a selection of said features within said searchable mapping of features which correlate to said approximate location, herein referred to as found data,
E. a step for extrapolating approximate locations for each of said fields except said primary field, within said primary map by shifting each of said approximate locations by the amount of shifting between a correlated point between said found data and said exemplar data associated with the most nearby field whose found data has been established, where the associated mapped field contains exemplar data.
F. step for establishing a mapping of a selection of said features within said searchable mapping of features which correlate to said approximate locations for each of said fields used in step E wherein such a mapping is requested for said field,
whereby a pattern of fields is precisely located on images of documents, the results being suitable for data processing including OCR processing.
whereby the amount of any extrapolating is kept to a minimum, thereby increasing robustness.

7. The process for locating data fields of claim 6 wherein said features are selected from the group consisting of: contiguous pixels of a given color, letters, words, horizontal lines, vertical lines, and unidentified image artifacts.

8. The process for locating data fields of claim 6 wherein there is an additional step for confirming that said selection of features established for each of said fields within said primary map is within the expectations for said field, and a method for responding when such requirements are not met,
whereby the validity of the application of a particular map on an image at a particular location can be determined, permitting the application of an exception management approach such as applying an alternative mapping, reusing said found data.

9. The process for locating data fields of claim 6 wherein there is an additional step for using one of said mappings associated with one of said fields within said primary map as said approximate location of said step C for re-applying the procedure, associating said approximate location with one of said mappings, and using one of said fields within said mapping,
whereby multiple mappings can be assembled together to form a large, dynamically positioned meta-map of an image's fields.

10. The process for locating data fields of claim 6 wherein there is an additional step for using one of said mappings associated with one of said fields within said primary map as said approximate location of said step C for re-applying the procedure, associating said approximate location with one of said mappings, and using one of said fields within said mapping,
whereby a complex repetition of the application of multiple mapping types can be consecutively applied to images, establishing the locations, types, and order of a multitude of fields on complex structured documents.
